(19) United States
(12) Patent Application Publication
(10) Pub. No.: US 2010/0103181 A1
(43) Pub. Date: Apr. 29, 2010

(54) ACTIVE MATRIX DISPLAY DEVICE

(75) Inventor: Kazuyoshi Kawabe, Kanagawa (JP)

Correspondence Address: EASTMAN KODAK COMPANY;PATENT LEGAL STAFF, 343 STATE STREET, ROCHESTER, NY, 14650-2201, US

(73) Assignee: EASTMAN KODAK COMPANY, Rochester, NY (US)

(21) Appl. No.: 12/531,496

(22) PCT Filed: Mar. 12, 2008
(86) PCT No.: PCT/US2008/003233

§ 371 Date: Sep. 16, 2009

(30) Foreign Application Priority Data
Mar. 29, 2007 (JP) 2007-086530

(51) Int. Cl. G09G 3/32; G06T 1/60; G09G 5/00; G09G 5/10

(52) U.S. Cl. 345/530; 345/211; 345/690; 345/77

(57) ABSTRACT

The application aims at reducing the power consumption of pixels not emitting light in an active matrix organic EL panel having a static memory cell in each pixel. Each pixel circuit comprises a selection transistor (5), first (2) and second (4) drive transistors as well as a first organic EL element (1) and a second (3) organic EL element respectively connected to the first and second drive transistors. The second organic. EL element is masked and does not contribute to the pixel brightness. The current flowing through the second organic EL element is reduced by current limiting means. This current limiting means may be a second supply voltage (VDD2) used in the current path with the second organic EL element, the second supply voltage being lower than the corresponding first supply voltage (VDD1) of the current path with the first organic EL element. Alternatively, the current limiting means may comprise a current limiting transistor (11) or a diode-connected transistor (13).

### FIELD OF THE INVENTION

The present invention relates to an active matrix display device comprising, in each pixel arranged in a matrix form, a self-emitting element and an element which controls light emission of the self-emitting element.

### BACKGROUND OF THE INVENTION

Active matrix display devices are capable of being made high resolution, and so are becoming widespread as displays. Active matrix display devices currently require active elements in order to determine a display state one pixel at a time. Particularly in the case of a current drive device such as an organic EL display, drive transistors capable of supplying electrical current to the light-emitting elements are provided. A thin film transistor (TFT) formed from a thin film such as amorphous silicon or polysilicon is used as such a drive transistor, but it is difficult to achieve uniform characteristics in a TFT.

A number of methods have been proposed for correcting TFT characteristics using circuit technology, one of which is digital drive, which is a known method for controlling gradation using digital drive of an active matrix organic EL display. For example in WO 2005/116971.

However, with digital drive 1 frame period is divided into a plurality of sub-frame periods, and bit data is written to control whether or not light is emitted in each sub-frame period. It is therefore necessary to write bit data for a pixel in 1 frame period by a number of times that is the same as the number of sub-frames.

In this way, in the case of digital drive to write digital data corresponding to respective bit data divided into sub-frames many times in a single frame period, if the wiring capacitance of the panel is large the power consumption will tend to be large. In particular, even if there is no image variation if the panel size is increased, power is consumed in order to write the bit data.

### SUMMARY OF THE INVENTION

The present invention is directed to an active matrix display device comprising, in each of a plurality of pixels arranged in a matrix form, a self-emitting element and an element which controls light emission of the self-emitting element, wherein each pixel includes, a static memory in which a first transistor of a pair of transistors is switched ON or OFF according to a supplied signal and a second transistor of the pair of transistors is switched OFF or ON according to an output voltage of the first transistor, so that the static memory maintains a state according to the supplied signal, and a pair of self-emitting elements each connected to each of the pair of the transistors of the static memory wherein a first self-emitting element contributes to display when a current is supplied and a second self-emitting element does not contribute to display even when a current is supplied, and wherein a current flowing through the second self-emitting element which does not contribute to display is reduced within a range which does not affect the state maintenance by the static memory.

Also, a power supply voltage for supplying current to the transistor, of the pair of transistors of the static memory, that is connected to the self-emitting element that does not contribute to display, is preferably made a lower voltage compared to the power supply for supplying current to the other transistor.

It is also possible for the transistors of the static memory to have a separate current control transistor connected in series with the transistor connected to the self-emitting element that does not contribute to display, and to adjust current amount flowing in the self-emitting element that does not contribute to display by adjusting the current amount of this current control transistor.

It is also possible for the transistors of the static memory to have a separate diode connected current control transistor connected in series with the transistor connected to the self-emitting element that does not contribute to display, and to reduce current amount flowing in the self-emitting element that does not contribute to display. It is also possible for the self-emitting element to be an organic EL element.

According to the present invention, by reducing a current flowing through a self-emitting element which does not contribute to display within a range which does not affect the state maintenance by the static memory, it is possible to lower the current amount when pixels are not emitting light.

### BRIEF DESCRIPTION OF THE DRAWINGS

FIG. 1 is a drawing showing a pixel circuit for limiting current using a second power supply voltage;

FIG. 2 is a drawing showing a pixel circuit for limiting current using a current limiting transistor;

FIG. 3 is a drawing showing another pixel circuit for limiting current using a current limiting transistor;

FIG. 4 is a drawing showing a pixel circuit for limiting current using a diode transistor;

FIG. 5 is a drawing showing another pixel circuit for limiting current using a current diode transistor; and

FIG. 6 is a drawing showing the overall structure of a display device.

### DESCRIPTION OF THE PREFERRED EMBODIMENTS

Embodiments of the present invention will be described in detail in the following using the drawings.

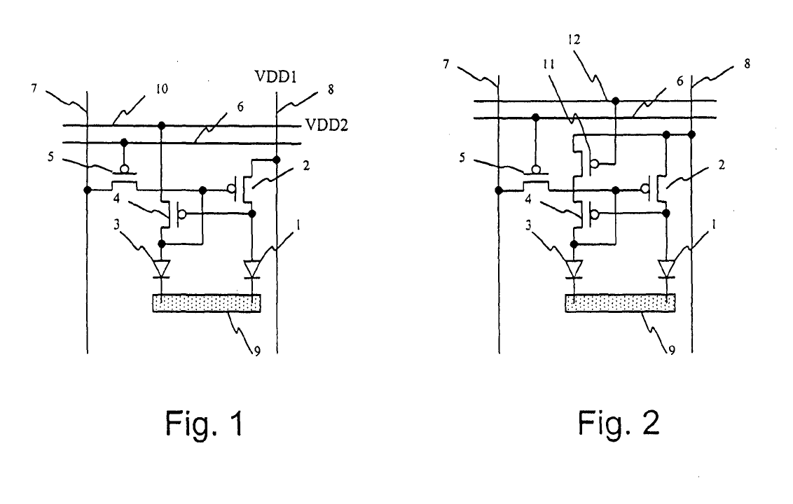

A pixel circuit of the present invention is shown in FIG. 1. The pixel circuit shown in FIG. 1 includes a first organic EL element 1 that contributes to display, a first drive transistor 2 for controlling lighting of the first organic EL element 1, a second organic EL element 3 that does not contribute to display, a second drive transistor 4 that controls lighting of the second organic EL element 3, and a gate transistor 5 that conveys data from a data line 7 to a gate terminal of the first drive transistor 2 in accordance with a selection signal supplied to a gate line 6.

An anode of the first organic EL element 1 is connected to a drain terminal of the first drive transistor 2 and the gate terminal of the second drive transistor 4. An anode of the second organic EL element 3 is connected to the drain terminal of the second drive transistor 4, the gate terminal of the first drive transistor 2, and the source terminal of the gate transistor 5. The gate terminal of the gate transistor 5 is connected to the gate line 6, while the drain terminal of the gate transistor 5 is connected to the data line 7. A source terminal of the first drive transistor 2 is connected to a first power supply line 8 for supplying a first power supply voltage VDD1, a source terminal of the second drive transistor 4 is connected to a second power supply line 10 for supplying a second power supply voltage VDD2, and cathodes of the first organic EL element 1 and the second organic EL element 3 are connected to a cathode electrode 9 to which a cathode power supply VSS is supplied.

With this type of structure, if the gate line 6 is selected (Low), digital data (High or Low data) that has been supplied to the data line 7 is conveyed to the gate terminal of the first drive transistor 2. If the digital data is low, the first drive transistor 2 is turned on, and at the same time as the anode of the first organic EL element 1 and the first power supply line 8 are connected to cause current to flow through the first organic EL element 1, the gate terminal of the second drive transistor 4 is connected to the first power supply line 8. Specifically, the second drive transistor 4 is turned off as a result of its gate potential becoming the first power supply potential VDD1, and simultaneously with the anode potential of the second organic EL element 3 dropping to the cathode potential VSS the gate of the first drive transistor 2 is also similarly lowered to the cathode potential VSS. As a result, the gate line 6 is made non-selected (High), and even if the gate transistor 5 is off lighting of the first organic EL element 1 continues, and the second organic EL element 3 is kept in an unlit state.

When the digital data is High, the first drive transistor 2 is turned off, and the anode of the first organic EL element 1 is lowered to the cathode potential VSS, but simultaneously with this the gate potential of the second drive transistor 4 also similarly falls to the cathode potential VSS and the second drive transistor 4 is turned on. If the second drive transistor 4 is turned on, the anode of the second organic EL element 3 is connected to the second power supply line 10, current is made to flow in the second organic element 3 by the anode of the second organic EL element 3 becoming the second power supply potential VDD2, and at the same time the gate potential of the first drive transistor 2 also becomes the second power supply potential VDD2. As long as the second power supply potential VDD2 is a sufficient potential to turn off the first drive transistor 2, then even if the gate transistor 5 is turned off the first organic EL element 1 is kept unlit and a state where current continues to flow in the second organic EL element 3 is maintained.

Since the structure is such that the first organic EL element 1 contributes to display by generating light, that is emitted when current flows, to the outside, but the second organic EL element 3 does not contribute to display because emitted light is not released to the outside even if current flows, the operation of the first organic EL element 1 determines a light emitting state of the pixel.

As a method of giving a structure such that emitted light is not released to the outside, as with the second organic EL element 3, there is a method of making the second organic EL element 3 itself an element that does not emit light, but this requires manufacturing steps to fabricate the first organic EL element 1 that emits light and the second organic EL element 3 that does not emit light, which complicates the manufacturing process. It is therefore easier to darken the second organic EL element 3 using metal or black matrix etc. so that there is no release of light to the outside. In any case, since the second organic EL element 3 does not contribute to display, formation is preferred where the light emitting surface area of the second organic EL element 3 is made small, and the light emitting surface area of the first organic EL element 1 is made large.

However, even when constructing the organic EL elements as described above, there is a limit to how small the second organic EL element 3 can be made, and current flowing from the second power supply line 10 is of an extent to maintain the gate potential of the first drive transistor 2 at an off level, even after the gate transistor 5 has been turned off.

Accordingly, with this embodiment, the second power supply potential VDD2 supplied to the second power supply line 10 is made smaller than the first power supply potential VDD1 supplied to the first power supply line 8, and current flowing in the second organic EL element 3 is limited by setting to a potential sufficient to turn off the first drive transistor 2, in other words, to at least the threshold voltage of the first drive transistor 2.

A potential that makes the power consumption extremely small while maintaining a state where the first organic EL element 1 is not lit is found by appropriately varying the second power supply potential VDD2, and if this potential is set as VDD2, it is possible to guarantee operation of the static memory while realizing low power consumption.

A pixel circuit of another embodiment is shown in FIG. 2. In FIG. 2, a current limiting transistor 11 is arranged in series between the second drive transistor 4 and the first power supply line 8. The gate terminal of the current limiting transistor 11 is connected to the current limit line 12, the source terminal is connected to the first power supply line 8, and the drain terminal is connected to the source terminal of the second drive transistor 4.

A control voltage supplied to the current limit line 12 is required to be at the threshold or below of the current limiting transistor 11 in order for current to flow in the second organic EL element 3, but it should be a value such that the potential of the second organic EL element 3 at this current is a sufficiently high level to turn the first drive transistor 2 off. That is, a minimum current that allows the second organic EL element 3 to keep the first drive transistor 2 off. In other words, the minimum current can generate a voltage that is the threshold or higher of the first drive transistor 2 so that the first transistor 2 keeps off state, and the first organic EL element 1 can maintain the unlit state by supplying a control voltage generated by the current limiting transistor 11 to the current limit line 12.

With FIG. 1, the structure is such that the off level of the first drive transistor 2 is directly controlled by using the second power supply potential VDD, but with FIG. 2, by controlling current flowing in the second organic EL element 3 using the current limiting transistor 11 the second power supply voltage VDD2 is generated and the off level of the first drive transistor 2 is controlled indirectly.

It is also possible to have the current limiting transistor 11 arranged in series between the second organic EL element 3 and the second drive transistor 4, with the gate terminal of the current limiting transistor 11 connected to the current limit line 12, the drain terminal connected to the anode of the second organic EL element 3, and the source terminal connect to the drain terminal of the second drive transistor 4, the gate terminal of the first drive transistor 2, and the source terminal of the gate transistor 5.

In this case, by using the current limiting transistor 11 the off voltage generated at the gate terminal of the first drive transistor 2 can be made substantially equal to the first power supply potential VDD 1, and it is possible to limit the current flowing in the second organic EL element 3 while maintaining an off state of the first drive transistor 2 in a more stable manner.

Also, as shown in FIG. 4, it is possible to arrange a diode transistor, having the gate terminal and drain terminal short circuited and operating as a diode, between the second organic EL element 3 and the second drive transistor 4, with the drain terminal (gate terminal) connected to the anode of the second organic EL element 3, and the source terminal connect to the drain terminal of the second drive transistor 4, the gate terminal of the first drive transistor 2, and the source terminal of the gate transistor 5.

Since the diode transistor 13 and the second organic EL element 3 are connected in series, a larger forward bias voltage is needed and current is limited.

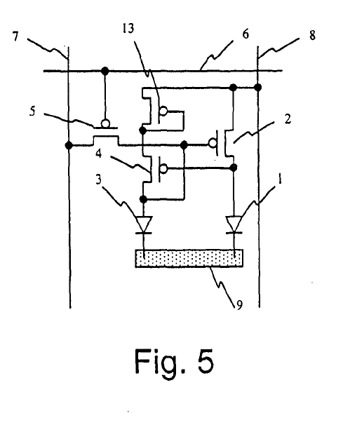

As shown in FIG. 5, it is also possible to have the diode transistor 13 arranged between the first power supply line 8 and the second drive transistor 4, with the source terminal connected to the power supply line 8, and the drain terminal (gate terminal) connected to the source terminal of the second drive transistor 4. In this case, the drain side voltage of the diode transistor 13 becomes a voltage supplied to the drain terminal (gate terminal) of the first drive transistor 2 when the second drive transistor 4 is on, namely, a voltage corresponding to the second power supply potential VDD2 in FIG. 1. Therefore, the voltage of the drain terminal (gate terminal) of this diode transistor 13 is required to be designed giving sufficient consideration to variations in characteristics of the diode transistor 13, so that it is made a sufficiently high potential to turn off the first drive transistor 2.

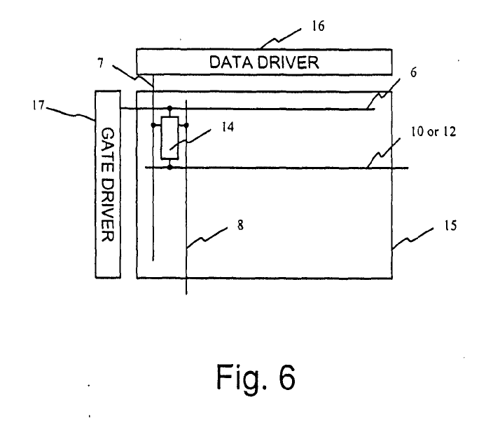

FIG. 6 shows a display device includes a pixel array 15 having the pixels 14 of FIG. 1 to FIG. 5 arranged in a matrix array, a gate driver 17 for driving gate lines 6, and a data driver 16 for driving data lines 7.

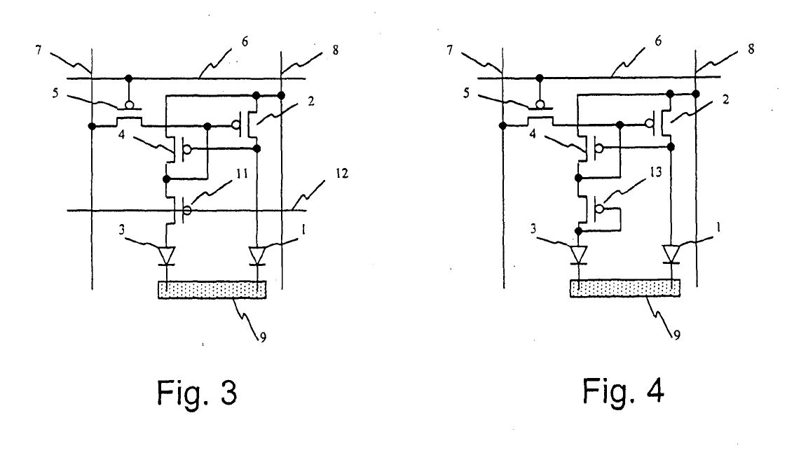

When a pixel 14 is as shown in FIG. 1, the second power supply voltage VDD2 is supplied to the second power supply line 10, while when configured as shown in FIG. 2 or FIG. 3 the current limit voltage is supplied to the current limit line 12. With the pixel 14 shown in FIG. 4 or FIG. 5, the second power supply line 10 and the current limit line 12 are not required, and so they are omitted.

In this manner, by controlling the voltage and current supplied to the second organic EL element 3 either directly or indirectly using a transistor, it is possible to lower the power consumption when maintaining an unlit state of the first organic EL element 1.

### PARTS LIST

1 organic EL element
2 first drive transistor
3 organic EL element
4 second drive transistor
5 gate transistor
6 gate line
7 data line
8 first power supply line
9 cathode electrode
10 second power supply line
11 current limiting transistor
12 current limit line
13 diode transistor
14 pixels
15 pixel array
16 data driver
17 gate driver

1. An active matrix display device comprising, in each pixel arranged in a matrix form, a self-emitting element and an element that controls light emission of the self-emitting element, wherein each pixel comprises:
a static memory in which a first transistor of a pair of transistors is switched ON or OFF according to a supplied signal and a second transistor of the pair of the transistors is switched OFF or ON according to an output voltage of the first transistor, so that the static memory maintains a state according to the supplied signal;
a pair of self-emitting elements, each connected to each of the pair of transistors of the static memory, wherein a first self-emitting element contributes to display when a current is supplied and a second self-emitting element does not contribute to display even when a current is supplied; and
means for flowing current through the second self-emitting element which does not contribute to display that is reduced to be within a range which does not affect the state maintenance by the static memory.

2. The active matrix display device of claim 1, wherein:
a power supply voltage for supplying current to the transistor, of the pair of transistors of the static memory, that is connected to the self-emitting element that does not contribute to display is made a low voltage compared to the power supply for supplying current to the other transistor.

3. The active matrix display device of claim 1, wherein:
a current control transistor separate from the transistors of the static memory is connected in series with the transistor connected to the self-emitting element that does not contribute to display, and current amount flowing in the self-emitting element that does not contribute to display is adjusted by adjusting the current amount of this current control transistor.

4. The active matrix display device of claim 1, wherein:
a diode connected current control transistor separate from the transistors of the static memory is connected in series with the transistor connected to the self-emitting element that does not contribute to display, and current amount flowing in the self-emitting element that does not contribute to display is reduced.

5. The active matrix display device of claim 1, wherein the self-emitting elements are organic EL elements.
